(19) United States
(12) Patent Application Publication
(10) Pub. No.: US 2004/0153871 A1
(43) Pub. Date: Aug. 5, 2004

(54) Automatic analysis of the properties of a system based on runtime logs

(76) Inventors: Andrej Pietschker, Munich (DE); Andreas Ulrich, Munich (DE)

Correspondence Address: STAAS & HALSEY LLP, SUITE 700, 1201 NEW YORK AVENUE, N.W., WASHINGTON, DC, 20005, US

(21) Appl. No.: 10/615,398

(22) Filed: Jul. 9, 2003

(30) Foreign Application Priority Data
Jul. 9, 2002 (DE) 10230883.7

(51) Int. Cl. H02H 3/05

(52) U.S. Cl. 714/47

(57) ABSTRACT

To analyze a complex, parallel system a runtime log is generated in XML or converted to XML after generation. This runtime log is examined for properties of the system. Interesting properties are described with XSLT resources. The XSLT resources are used to filter and display the analysis results visually.

### CROSS REFERENCE TO RELATED APPLICATIONS

This application is based on and hereby claims priority to German Application No. 102 308 83.7 filed on Jul. 9, 2002, the contents of which are hereby incorporated by reference.

### BACKGROUND OF THE INVENTION

When testing complex systems, which often operate in parallel and on a distributed basis, runtime logs are generated in the form of traces or logs. They contain information about system behavior during operation of the system, either in test runs or in actual applications. The compiled information is used for error analysis, to reproduce system behavior. Modern complex systems supply large quantities of information in these runtime logs, which is difficult to analyze manually. Complex interrelationships within the system are also difficult to analyze manually.

Nevertheless the runtime logs are generally analyzed manually. To some extent special solutions are also developed, which execute analyses in a manner that is tailored to the system environment and the error pattern to be examined. These solutions are very expensive to produce and maintain. In the literature there are also general approaches that disclose automatic analysis of runtime logs. A method is known from Hallal H. et al.: “Using SDL-Tools to Test Properties of Distributed Systems”, in: Brinksma E. and Tretmans J. (editors): “Formal Approaches to Testing of Software—FATES '01”, pages 125-140, Aalborg, Denmark, August 2001, in which runtime logs for automatic analysis are generated in Specification and Description Language (SDL). However complex and expensive tools are required for this approach, which cannot therefore be widely used.

### SUMMARY OF THE INVENTION

An object of the invention is to simplify and automate the analysis of complex technical systems. In doing so the disadvantages described above should be avoided.

With a method for analyzing the functional reliability of a technical system, a runtime log in the form of a trace or log is generated by one or more computers for the purposes of error analysis. The runtime log contains information about system behavior during operation of the system in the form of information about at least one event, especially a number of events, occurring during operation of the system. The runtime log is generated in Extensible Markup Language (XML) or converted to XML after generation.

Conventionally, a modeling language, e.g. SDL, may be used for automatic analysis to verify a complex system. The system is modeled with this modeling language, as it is simulated by a runtime log.

With the use of XML the invention is based on a quite different approach. For XML is not a modeling language and was not created to show sequences. Rather XML is usually a structuring language, with which quantities of data can be shown in a structured manner. The invention is therefore based on the idea not of generating the runtime logs as just text to be processed manually nor of generating a formal model with the generation of the runtime logs but rather of generating a structured output in XML, which can then be subjected to subsequent automated processing. Therefore in practice the invention lies between the procedures known from the prior art.

This has the advantage of automation compared with the manual procedure. Compared with the model-based approach, it has the advantages of a lower level of complexity of the generated runtime logs and significantly reduced costs for further processing these.

The runtime log is also generated in a standard format at the same time or is converted to this after generation. The standard format for the runtime log is described in an XML layout.

It is advantageous to provide a specific XML format for the runtime logs that contains specific data.

The runtime log in particular contains the name and nature of the event.

The data can also include whether the event is a local event, a registration event or a communication event. Local events are events that occur locally in a system component. A system component in particular refers to a parallel execution procedure (thread) of an application, a device (in the form of a virtual or actual hardware component), a process or an object. Local events are for example events such as variable allocations and verifications of assertions.

Devices, processes, execution procedures and objects can be registered and unregistered during operation of the system. These events are registration events. They define the life of their source and allow other events to be tailored to hardware or software processes.

The sending and receiving of messages are communication events. This group of events also includes remotely controlled method inquiries.

It is also advantageous if the runtime log contains data about parameters of the system component initiating the event or associated with the event, in particular data that can be used to identify the system component.

The system component can in particular be a system component receiving a message or sending a message, or both.

In this case the runtime log can contain data about message parameters, in particular in order to identify the message.

It is particularly advantageous if the runtime log is verified for correct XML syntax by computer-assisted parsing. This allows the automatic verification of the runtime log for syntactic and to some degree semantic correctness. Low cost standard XML parsers can be used for this.

In a particularly preferred embodiment of the invention the runtime log is further processed by Extensible Style-Sheet Language Transformation (XSLT) resources. The use of XSLT resources has the following advantages:

XSLT resources are easily portable;

the properties sought can be simply expressed;

XSLT resources can be re-used, for example to search for other properties;

XSLT resources are flexible and can therefore be used for a wide range of analysis tasks.

These advantages are due to the fact that XSLT is a functional programming language tailored to XML.

For the further processing of the runtime log by XSLT resources the property of the system to be examined is expressed in XSLT notation. Analysis and visual display modules are then generated automatically as XSLT resources. Each module represents an independent executable program. An analysis module processes a runtime log in XML notation and during the analysis of the coded property contained in this it generates a modified runtime log, which can be processed by further XSLT resources.

An XSLT tool can in particular include a filter function, by which the property or other properties can be filtered.

At the end of the analysis the runtime log is converted to a suitable visual representation. XSLT resources are used for this purpose for the visual display, for example for representation in Scalable Vector Graphics (SVG), Hypertext Markup Language (HTML) or encapsulated Postscript.

A system equipped to execute one of the described methods can be achieved with the provision of resources, by which the stages of the method can be executed. Preferred embodiments of such an arrangement result in the same way as the preferred embodiments of the method.

A program product for a data processing unit containing software code segments, with which one of the described methods can be executed on the data processing unit, can be achieved by suitable implementation of the method in a programming language and conversion into a code that can be executed by the data processing unit. The software code segments are stored for this purpose. Program product here refers to the product as a marketable product. It can exist in any form, for example on paper, a computer-readable data medium or distributed via a network.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram showing the use of XML in the analysis of runtime logs;

FIG. 2 is a block diagram of a structuring specification for events in XML;

FIG. 3 is a block diagram for conversion of a runtime log using XSLT resources;

FIG. 4 is a graph of an execution procedure for a simple runtime log;

FIG. 5 is a block diagram of a sequence of filters;

FIG. 6 a block diagram showing the use of runtime log analysis tools;

FIG. 7 is an output listing for a performance analysis; and

FIG. 8 is a graphic representation of an analysis.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Overview of an Analysis Method with Runtime Logs

The use of XML standard technologies is proposed for analyzing system runtime logs. This minimizes development costs for special tools.

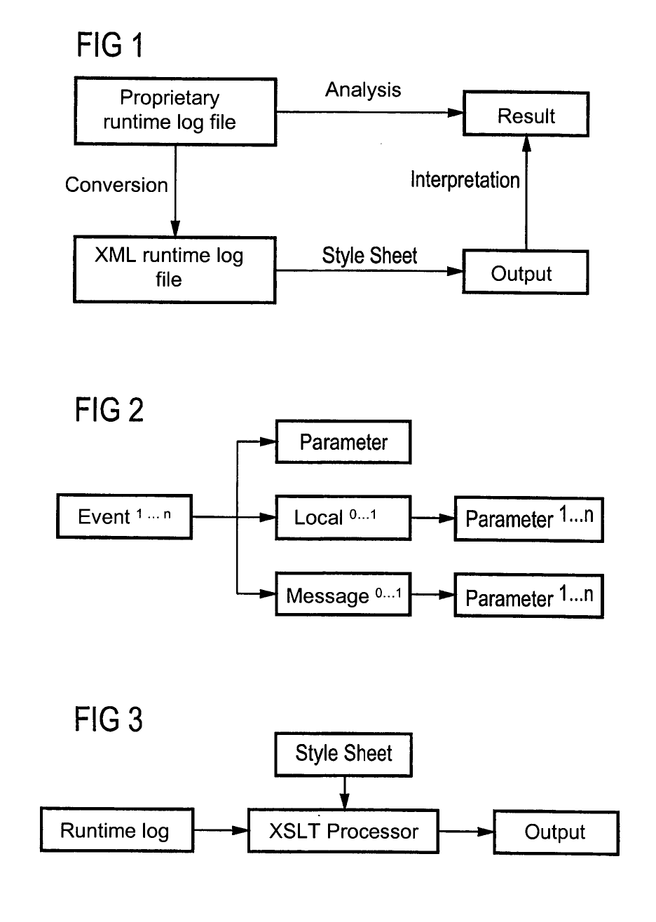

The diagram in FIG. 1 illustrates this idea. Instead of concentrating on the semantic analysis of runtime logs, a syntactic transformation stage is applied, in order to obtain a corresponding event automatically. It is however important here to establish that the analysis is restricted to those properties, which can be described syntactically.

The approach is based on runtime logs in XML notation. This means that runtime logs based on syntactical rules can be analyzed in conjunction with the transformation technology XSLT. The properties of the system can be deduced from information which is extracted in more extensive transformations and a visual examination of the result.

In this runtime log analysis method

a runtime log of the system is observed containing a list of partially ordered events for the registration of execution procedures and objects, communications and local events;

a runtime log is converted offline to an XML-based runtime log,

a description of interesting properties is generated using XML-style sheets (XSL),

the style sheets are applied to XML output logs using XSLT resources.

The runtime log analysis method provides both an overview and zoom and filter functions as well as specific details of required events in the runtime log on request.

Runtime log information is made accessible to users by a visual display. The SVG format is preferably used for this. SVG is an XML-based format for graphic representation. It provides a range of tools for displaying SVG content. This means that there is no need to set up a specialized output unit.

Runtime logs for complex systems are often extremely large and therefore not user- friendly. Filter operations are used in the method to reduce the information contained in the runtime log and thereby the size of the runtime log. These operations have to be precise and consistent.

Not all information should be continuously present in the representation of the runtime log, or the display would be overloaded and it would be extremely difficult to select relevant information. However it should be possible to make more detailed information available easily to users during the examination of events.

Structure and Content of the Runtime Log

Events are compiled during the operation of a system. A distinction is made here between the following classes of event:

Registration events

Communication events

Local events

As a runtime log is used as input for the method for analyzing a system, resources have to be available in the system to generate events for the runtime log at specific points. There are different methods for integrating such resources into a system. The most promising are those that operate automatically. These include methods based on Microsoft COM, Java RMI or CORBA for example.

In order to be used in the runtime log analysis, every runtime log event that is a communication event or a local event should advantageously have the following structure and the corresponding data:

Name and type of event: sending event, receiving event or local event;

ID of initiating execution procedure or initiating object;

ID of source execution procedure and source object (for receiving events);

ID of destination execution procedure and destination object (for sending events);

Parameters of the message for the event: a list of parameters containing a name for the message and other message attributes (for communication events);

local parameters of the initiating execution procedure or the initiating object: a list of parameters showing current status (for local events).

Registration events also occur that introduce newly generated execution procedures, processes or objects into a runtime log. It is assumed that the local sequence of all events is maintained in the same sequence in the runtime log. The problem of assigning receiving and sending events is significant in respect of determining the sequence of events and ultimately basing the analysis on the recorded runtime log. Much depends on how that distributed system is set up and what is actually displayed. It is assumed that in a pair formed by a source and a destination process every receiving event is associated with an individual sending event. The partial sequence (partial order) in which events take place in a distributed system can be described using the binary Happened-Before-Relation “→”, which is the theoretical basis of this approach. It is defined as follows:

If event e in execution procedure t precedes the event e′ in the same execution procedure t, then e→e′.

If event e is a sending event in execution procedure t and event e′ the corresponding receiving event in execution procedure t′, then e→e′.

The Happened-Before-Relation is transitive.

FIG. 2 illustrates the XML format of an event. An event is described by its type and its operation. Therefore for example a sending event has the type “communication” and the operation “send”. Every event contains a “Parameter” element, which, as explained above, contains information about the origin of the event. An event can also have the element “local”, with information about the status of local variables. Communication events contain a “message” element with the respective content of the message.

The format is specified as Document Type Description (DTD), allowing the use of XML parsers for verifying a output protocol file for syntactical correctness.

Visual Display Components

Runtime logs are converted to their graphic representation by style sheets using XSLT resources in the form of a style sheet processor or an XSLT processor. FIG. 3 illustrates this part of the method, for which quite a large number of processors are already available free of charge.

With an SVG viewer plug-in for web browsers it is possible zoom in and out of the graphic representation. In this way users can obtain an overview if they wish or zoom into the graphic, to find detailed information. As this is a vector-based format, the quality of the graphic is high at every zoom stage. Two different views of a runtime log are provided:

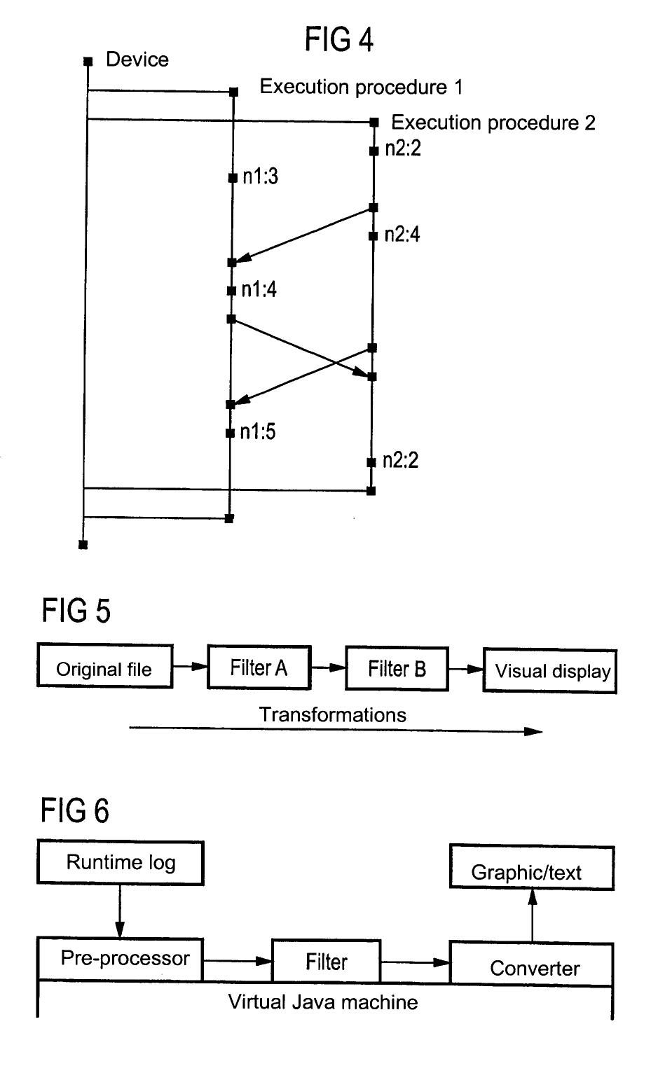

The execution procedure view. This view is similar to a message sequence view, with vertical lines representing the active time of a task. Communication events between tasks are shown by lines which link the corresponding sending and receiving events (see FIG. 4).

Object view. This presentation is also similar to the message sequence view, with vertical lines representing object lives.

Events in the graphic are color-coded. The use of colors makes it easier to identify events. As a result it is easy to distinguish between different types of events. Local events are marked in yellow for example. The colors are defined in a cascading style sheet, which is stored in a separate file and can be adjusted to personal preferences.

FIG. 4 shows an execution procedure view of a simple runtime log, with all events shown at a specific interval. This representation is preferably used when only the sequence of events is of interest. Time markers can however also be used in the runtime log to show times between events as intervals. Such a graphic can be very helpful when investigating properties over time.

The requirement that details should be displayed on demand is implemented in two ways. One way is the use of a separate HTML file with references linking entries on the graphic to the text representation. In this way the graphic contains the information relating to the interaction of the objects or runtime procedures and the HTML file supplies the file view of the event entries. A combination of these views can be used if HTML frames are used.

In a second implementation the capacity of SVG to animate text is used. Moving the mouse pointer over a specific event here causes information such as event parameters or messages to be displayed. When the mouse pointer is moved away, the information is removed again. This approach has the advantage that only one file has to be used to display all information. Nevertheless it has been demonstrated that in the case of large files the speed of opening the relevant file and animating causes a performance bottleneck.

Filters

The size of the graphic and the quantity of information it represents can still cause problems. The removal of irrelevant information from runtime logs by filters can significantly reduce their size and thereby ensure that relevant information is displayed during the visual examination.

According to the visual display method filters are preferably implemented as style sheets and processing is in turn managed by XSLT resources in the form of an XSLT processor.

Xpath voice structures can be used to express event templates, which are either the subject of a search or which are to be temporarily ignored. Examples of such filters are:

The removal of local events

The selection of communication events between runtime procedures

The selection of communication events between objects

Local events are not of particular interest, when the focus is on communication between system components. Local events can be removed by using style sheets according to example 1.

### Example 1

<?xml output=“1.0” encoding=“utf-8”?>
<xsl:stylesheet

xmlns:xsl=“www.w3.org/1999/XSL/Transform”
output=“1.0”>

<!-- Description: Stylesheet removes all events of type

‘Local’ -->

<!-- Import standard behavior -->
<!-- standard: copy all events -->
<xsl:import href=“filter_template.xsl”/>
<!-- Add DOCTYPE -->
<!-- create trace.dtd file -->
<xsl:output method=“xml” indent=“yes” doctype-

system=“trace.dtd”/>

<xsl:strip-space elements=“*”/>
<!-- Match local events -->
<!-- do not copy (delete) them -->
<xsl:template match=“event[@operation=‘Application’ and

@type=‘Local’]”>

</xsl:template>
<!-- end Match local events -->

</xsl:stylesheet>

Operations with Filters

The result of a filter operation is a modified runtime log, which is valid and can be further processed for visual display or analysis. It is therefore possible, as shown in FIG. 5, to use a combination of filters.

This operation is called chaining. It should however be ensured that filter chaining is not commutative:

filter1∘filter2≠filter2∘filter1

Style sheets as in example 2, in which a general style sheet is imported in line 8, that generates copies of the event in the resulting file as standard, can be re-used.

### Example 2

<?xml output=“1.0” encoding=“utf-8”?>
<xsl:stylesheet

xmlns:xsl=“www.w3.org/1999/XSL/Transform”
output=“1.0”>

<!-- Description: Stylesheet removes all threads with no

events -->

<!-- Import standard behavior -->
<!-- standard: copy all events -->
<xsl:import href=“filter_template.xsl”/>
<!-- Add DOCTYPE -->
<!-- output trace.dtd -->
<xsl:output method=“xml” indent=“yes” doctype-

system=“trace.dtd”/>

<xsl:strip-space elements=“*”/>
<!-- Remove threads with no events -->
<xsl:template match=“event[@type=‘Thread-Registration’

and (@operation=‘Create’)]”>

<xsl:variable name=“found-events”

select=“following-sibling::event[(@type=‘Communication’ or @type=‘Local’)
and parameters/@thread-id=current()/parameters/@identifier]”/>

<xsl:if test=“count($found-events) > 0”>
<xsl:copy-of select=“.”/>
</xsl:if>
</xsl:template>
<xsl:template match=“event[@type=‘Thread-Registration’

and (@operation=‘Destroy’)]”>

<xsl:variable name=“found-events”

select=“preceding-sibling::event[(@type=‘Communication’ or @type=‘Local’)
and parameters/@thread-id=current()/parameters/@identifier]”/>

<xsl:if test=“count($found-events) > 0”>
<xsl:copy-of select=“.”/>
</xsl:if>
</xsl:template>

</xsl:stylesheet>

It is then possible to write the rules over from the general style sheet in order to comply with the special requirements in the relevant application. Priority rules are used here.

Instead of importing from style sheets, style sheets can also be included, as in lines 6 to 7 in example 3. Rules from included style sheets have the same priority as rules on the current style sheet. These priority rules can be used to write rules over from imported style sheets. In this way general templates can be re-used, thereby reducing the development costs for analysis tools.

### Example 3

<?xml output=“1.0” encoding=“utf-8”?>

<xsl:stylesheet

xmlns:xsl=“www.w3.org/1999/XSL/Transform”
output=“1.0”>

<!-- Description: Stylesheet removes all empty threads

and objects -->

<xsl:include href=“filter_emptythread.xsl”/>
<xsl:include href=“filter_emptyobject.xsl”/>
<!-- Add DOCTYPE -->
<!-- output trace.dtd -->
<xsl:output method=“xml” indent=“yes” doctype-

system=“trace.dtd”/>

<xsl:strip-space elements=“*”/>

</xsl:stylesheet>

Property Analysis

The idea of using style sheets for filters can be transferred to the analysis of properties in a runtime log.

Analysis of data overhauls. Data overhauls can occur in a distributed system, when an object is accessed from more than one execution procedure. This is a standard analysis for distributed systems.

Deadpoint analysis. A deadpoint can occur in a system, when a component actively awaits an event that never occurs.

Generally these properties are examined using models of the system and require formal verification. This can be extremely cost-intensive and in some cases still fails to yield the required results.

The analysis carried out here is based only on runtime logs. The results can only identify possible problems however. These problems then have to be examined manually. Nevertheless this is significantly easier after possible problem areas have been identified. Also performance bottlenecks based on the time between events in the runtime log can also be examined.

The properties are formulating using conditions for events in the runtime log: Condition for potential data overhaul:

∀ e ε Event,

where e/@ type ε{Local, Communication}

T_{@object-id}={c/parameters/@thread-id|c ε Event,

where c/@type ε {Local, Communication}

and c/parameters/@ object-id≠e/parameters/@ object-id},

a potential data overhaul is then identified as:

race-condition=|T_{@object-id}|>1

The condition proves valid, if more than one runtime procedure uses the object identified as @object-id.

Condition for a highly probable data overhaul:

If the condition for a potential data overhaul is satisfied, the analysis can be continued, in order to identify a highly probably data overhaul. For this it must be verified whether the identified runtime procedures are actually simultaneous, i.e. the events in these runtime procedures are simultaneous.

∀ e, e′ ε Event,

where e/@thread-id≠e′/@ thread-id and

e/@object-id=e′/@object-id,

then e→e′ and e′→e apply, if events e and e′ are not simultaneous.

Possible Deadpoint:

∀ e ε Event,

where e/@type=Communication, e/@operation=Send and e/parameters/@thread-id=t,

a possibly blocked runtime procedure is identified by:

deadlock-condition=e is the last event in t.

These general templates can be used in every simultaneously operating or distributed system. However there are also many application-specific properties, which can be described using such templates. These templates can be derived from the system requirements, in order to verify the correct behavior of the system to be tested. Templates can also describe errors, which emerge in previous tests. These templates can be used in subsequent tests to verify whether such an error has emerged again. The application-specific properties generally represent the majority of the runtime log analysis in practice. The proposed method simplifies the description of these properties as a template and thereby increases productivity in the test phase significantly.

Deployment of Runtime Log Analysis Tools

Style sheets and associated processors are readily available to engineers, as long as they are familiar with XSLT technology. They can also be made available to a wider group by a technology known as translated style sheets. This can be used to install the analysis tools, rather than supplying users with style sheets. In this case a compiler generates a Java program for example from a specific style sheet. This allows the properties being sought to be expressed further in XSLT and means that Java programs can easily be installed for developers containing implemented filters, processors and converters. One example of such Java implementation is shown in FIG. 6.

### EXAMPLE

One example of the method is created for an embedded software system operating with Windows CE.

The runtime logs are generated in a proprietary format and then converted offline to the XML-based runtime log format.

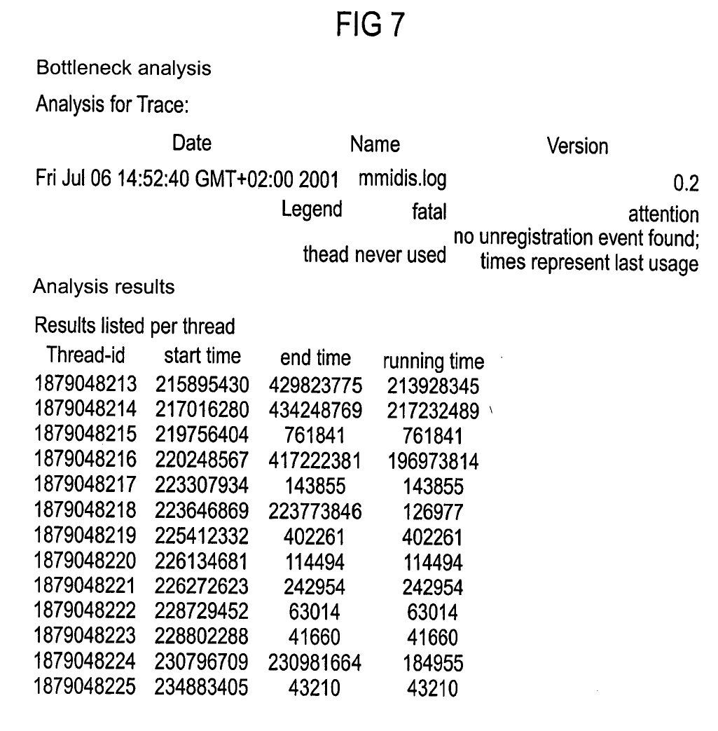

Of particular interest in this example is the reason why the application is significantly slowed down. The runtime logs themselves are extremely large and contain millions of events. The challenge is to find calls that can cause the slowing down process. First the performance of the calls is analyzed. A style sheet is used for this that finds pairs of call and return events and calculates the time difference. The result is presented as an HTML file (FIG. 7).

After identifying the performance bottlenecks, the reason is sought for these delays. In the example given, error events are examined in more detail. The error events in this case are either local events, which contain the word “error” in the message or communication events containing a specific return result. A style sheet is in turn implemented only to filter out and display these events visually.

The color-coding system, the reduced amount of information and the possibility of obtaining a fast overview of the runtime log allow implementation failure to be identified as the reason for the slowing down.

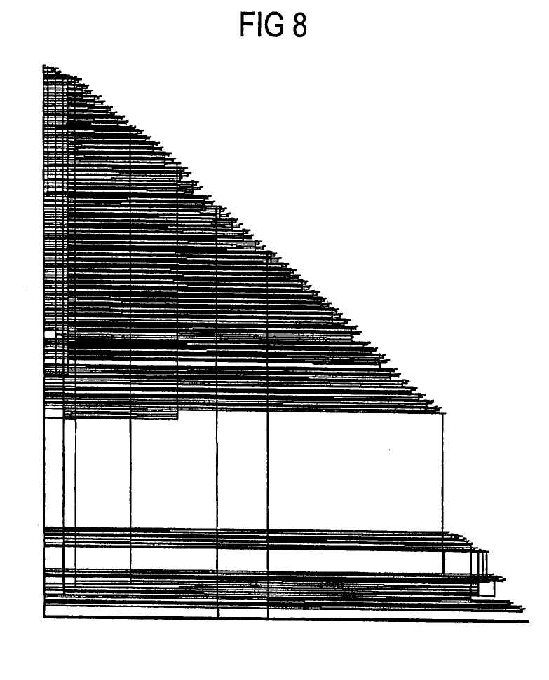

FIG. 8 shows an overview of this analysis. The graphic contains 26656 events and is shown in an extreme zoom position to allow an overview. In the middle of the lower part of the runtime log a gap is clearly visible, characterized by an accumulation of error events. Examination shows that the application is slowed down by this, because unnecessary inquiries are processed. Further research shows that a component is trying to access a defective device in synchronous mode. Processing in this object is paused until a timeout allows the system to continue. The required improvement can be achieved in this specific case by managing available devices in a central component.

Generally the embodiments of the invention have the following advantages. Analysis modules can be set up quickly and efficiently in the form of XSLT resources through the use of XML technologies. Specific modules can be set up and tested at very low cost as a result. The tools required for generation are available free of charge. Runtime logs can be automatically searched for complex system properties. Widespread use of these modules is easy to establish. A large number of small analysis modules gives a high level of flexibility for the analysis of runtime logs. The automatic analysis of runtime logs results in an increase in productivity during error analysis. The use of SVG and HTML as visual display resources allows a web-based representation with the associated advantages.

The invention has been described in detail with particular reference to preferred embodiments thereof and examples, but it will be understood that variations and modifications can be effected within the spirit and scope of the invention.

What is claimed is:

1. A method for analyzing a system, comprising:
producing a runtime log in Extensible Markup Language, the runtime log containing information about an event during the operation of the system.

2. A method according to claim 1, wherein the runtime log contains a number of events and a partial sequence of events is described using the runtime log.

3. A method according to claim 2, wherein the partial sequence of events is described using a Happened-Before-Relation.

4. A method according to claim 3, wherein said generating includes details of first parameters of an event in the runtime log to at least one of identify the event and indicate whether the event is a local event, a registration event or a communication event.

5. A method according claim 4, wherein said generating includes details of second parameters of a system component initiating the event, by which the system component can be identified.

6. A method according to claim 5, wherein the system component at least one of receives and sends a message.

7. A method according to claim 6, wherein said generating includes details of third parameters of the message in the runtime log to identify the message.

8. A method according to claim 7, further comprising verifying the runtime log for correct XML syntax.

9. A method according to claim 8, further comprising processing the runtime log by Extensible Style-Sheet Language Transformation resources.

10. A method according to claim 9, wherein said processing by the Extensible Style- Sheet Language Transformation resources includes application of a filter function.

11. A method according to claim 10, wherein said processing by the Extensible Style- Sheet Language Transformation resources generates a modified runtime log in XML from the runtime log.

12. A method according to claim 11, wherein said processing by the Extensible Style- Sheet Language Transformation resources includes application of a visual display function.

13. A method according to claim 12, wherein a number of Extensible Style-Sheet Language Transformation resources are used, which can be combined and executed in any sequence.

14. A computing system, comprising:
a data processing unit programmed to produce a runtime log in Extensible Markup Language, the runtime log containing information about an event during the operation of the computing system.

15. At least one computer readable medium storing instructions to control a data processing unit to perform a method comprising:
producing a runtime log in Extensible Markup Language, the runtime log containing information about an event during the operation of the system.
